(19) United States
(12) Patent Application Publication
(10) Pub. No.: US 2009/0158629 A1
(43) Pub. Date: Jun. 25, 2009

(54) INTERNALLY ILLUMINATED SIGNAGE INCLUDING A LIGHT BAR AND LIGHTING DEVICES THEREFOR

(76) Inventors: James Bears, Palm City, FL (US); Matthew J. Hollister, Stuart, FL (US); Michael C. Romeo, Port St. Lucie, FL (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/341,477

(22) Filed: Dec. 22, 2008

Related U.S. Application Data
(60) Provisional application No. 61/015,460, filed on Dec. 20, 2007.

(51) Int. Cl. G09F 13/18; F21V 29/00

(52) U.S. Cl. 40/546; 362/373; 362/294; 362/234; 40/582

(57) ABSTRACT

A signage apparatus includes a translucent substrate having displayed thereon a textual image and/or a graphic image. The substrate has a plurality of edges. A plurality of light devices are aligned along one of the edges of the substrate. Each of the lighting devices is oriented to emit a respective beam of light in a direction generally parallel to the substrate.

### RELATED APPLICATION

The present invention claims priority to U.S. Provisional Patent Application No. 61/015,460, entitled “INTERNALLY ILLUMINATED SIGNAGE INCLUDING A LIGHT BAR AND LIGHTING DEVICES THEREFOR”, filed Dec. 20, 2007, which is incorporated herein by reference.

### BACKGROUND OF THE INVENTION

1. Field of the Invention

The present invention relates generally to signage and, more particularly, to backlit or internally illuminated signage.

2. Description of the Related Art

It is known for signs to be printed on a translucent substrate, such as frosted glass, which is then backlit by elongate fluorescent tubes that may be a few inches behind the substrate. Because the fluorescent tubes are in close proximity to the sign and directly illuminate it, the sign may be unevenly backlit. That is, the sign may appear to have stripes that are alternatingly brightly lit and dimly lit. The brightly lit stripes may have a fluorescent tube directly behind them, and the dimly lit stripes may have no fluorescent tube directly behind them. Such uneven backlighting may be unaesthetic for the viewer, and may make the sign more difficult to read.

### SUMMARY OF THE INVENTION

The present invention is directed to a signage apparatus that is illuminated by a row of lighting devices that are positioned at an edge of the sign and that are aligned in a direction parallel to the face of the sign. Each lighting device is oriented to emit a cone of light in a direction parallel to the face of the sign. Reflective surfaces may be provided at other edges of the sign such that the light from the lighting devices may be reflected back onto the sign.

The invention comprises, in one embodiment thereof, a signage apparatus including a translucent substrate having displayed thereon a textual image and/or a graphic image. The substrate has a plurality of edges. A plurality of light devices are aligned along one of the edges of the substrate. Each of the lighting devices is oriented to emit a respective beam of light in a direction generally parallel to the substrate.

The invention comprises, in another embodiment thereof, a signage apparatus including a translucent substrate having displayed thereon a textual image and/or a graphic image. The substrate has a plurality of edges. A plurality of first light devices are aligned along a first of the edges of the substrate. Each of the first lighting devices is oriented to emit a respective beam of light in a first direction generally parallel to the substrate. A plurality of second light devices are aligned along a second of the edges of the substrate. Each of the second lighting devices is oriented to emit a respective beam of light in a second direction generally parallel to the substrate.

The invention comprises, in yet another embodiment thereof, a lighting arrangement including a thermally conductive plate having a through-hole. The lighting arrangement also includes a lighting device having an integral, thermally conductive housing having a body snugly received in the through-hole. The housing also has a flange disposed around an open end of the body. The flange has a width greater than a width of the through-hole. A substantially flat surface of the flange engages the plate. A lighting element is disposed within the body and is in thermal communication with the housing. The light element is oriented to emit light directly through the open end of the body.

An advantage of the present invention is that a backlit or internally illuminated sign may be evenly illuminated.

Another advantage is that heat from the lighting elements may be carried away from the lighting element at a high rate, thereby increasing the durability of the lighting elements.

### BRIEF DESCRIPTION OF THE DRAWINGS

The above-mentioned and other features and advantages of the invention will become more apparent to one with skill in the art upon examination of the following figures and detailed description. The components in the figures are not necessarily to scale, emphasis instead being placed upon illustrating the principles of the invention. Moreover, in the figures, like reference numerals designate corresponding parts throughout the different views.

FIG. 1 is a perspective view of one embodiment of an internally illuminated signage apparatus of the present invention.

FIG. 2 is a perspective view of the signage apparatus of FIG. 1 in an opened state wherein a light bar of the signage apparatus is accessible.

FIG. 2a is a view along line 2a-2a in FIG. 2 in a particular embodiment.

FIG. 3 is a fragmentary perspective view of the signage apparatus of FIG. 1 in an opened state wherein both the light bar and the batteries of the signage apparatus are accessible.

FIG. 4 is a perspective view of the light bar of the signage apparatus of FIG. 1.

FIG. 5 is a perspective view of the frame of the light bar of FIG. 4.

FIG. 6 is an exploded perspective view of a lighting device of the light bar of FIG. 4.

FIG. 7 another exploded perspective view of a lighting device of the light bar of FIG. 4.

FIG. 8 is a perspective view of the lighting device of FIGS. 6 and 7 in an assembled state with an O-ring coupled thereto.

FIG. 9 is a side view of the lighting device and O-ring of FIG. 8.

FIG. 9a is a side view of the lighting device and O-ring of FIG. 8 attached to a metal plate.

FIG. 10 is a cross sectional view of the lighting device and O-ring of FIG. 9 along line A-A.

FIG. 11 is an end view of the lighting device and O-ring of FIG. 9 along line 11-11.

FIG. 12 is a perspective view of the housing of the lighting device of FIG. 6.

FIG. 13 is a perspective view of the plug of the lighting device of FIG. 6.

FIG. 14 is a cross sectional view of the housing of FIG. 12 along line 14-14.

FIG. 15 is another cross sectional view of the housing of FIG. 12 along line 14-14 showing the internal threads.

FIG. 16 is a cross sectional view of the plug of FIG. 13 showing the external threads.

FIG. 17 is a perspective view of a lens clamp ring of the lighting device of FIG. 6.

FIG. 18 is a cross sectional view of the lens clamp ring of FIG. 17 along line 18-18.

FIG. 19 is a perspective view of another embodiment of a lighting device of the present invention in an assembled state and with a cap assembled thereto.

FIG. 20 is a side view of the lighting device and cap of FIG. 19.

FIG. 21 is a side, cross sectional view of the lighting device and cap of FIG. 20.

FIG. 22 is an end view of the lighting device of FIG. 20 along line 22-22.

FIG. 23 is a front view of another embodiment of an internally illuminated signage apparatus of the present invention.

### DETAILED DESCRIPTION OF THE PRESENTLY PREFERRED EMBODIMENTS

The embodiments hereinafter disclosed are not intended to be exhaustive or limit the invention to the precise forms disclosed in the following description. Rather the embodiments are chosen and described so that others skilled in the art may utilize its teachings.

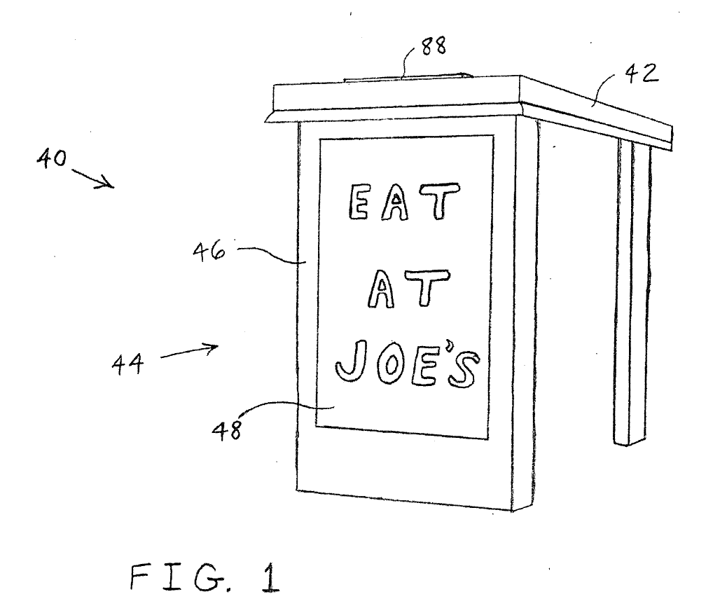

Referring to FIG. 1, there is shown one embodiment of a signage apparatus 40 of the present invention mounted as a supporting member for an end of a roof 42 of a shelter 44, such as for a bus stop. Signage apparatus 40 includes a metal frame 46 that retains a translucent substrate 48, which may be formed of glass or plastic, for example. Substrate 48 may have a graphical image and/or a text message printed thereon as shown in FIG. 1.

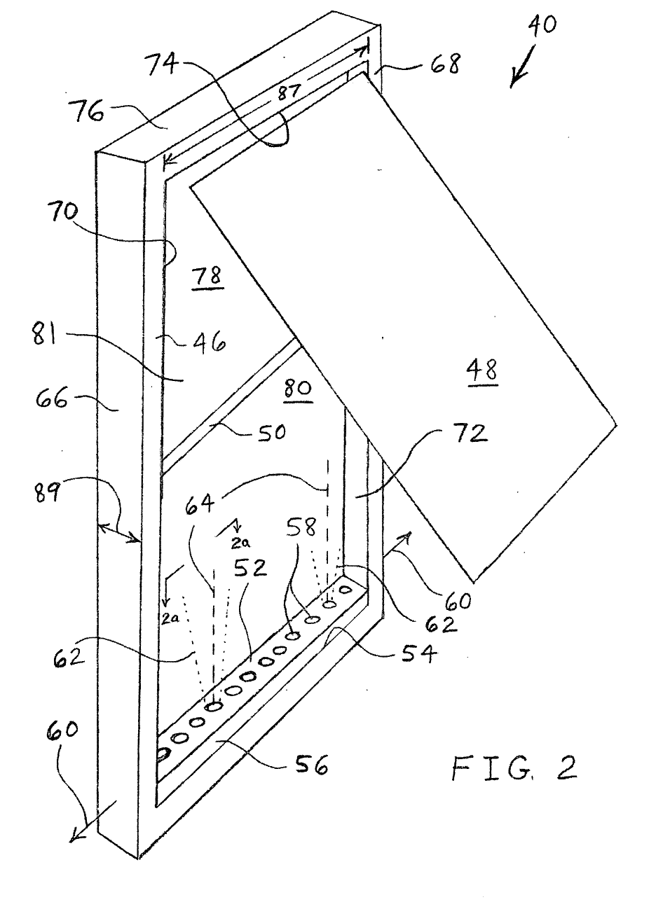

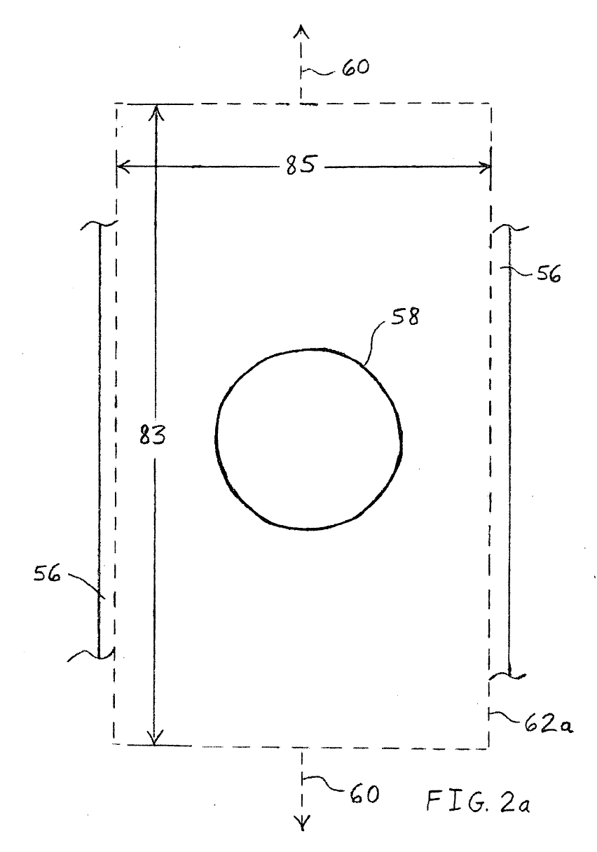

Substrate 48 may be attached to pivotable support arms 50, one of which is visible in FIG. 2, such that substrate 48 may be moved away from frame 46 to expose a light bar assembly 52. Light bar assembly 52 may be mounted on a bottom inner surface 54 of frame 46, as shown in FIG. 2.

Light bar assembly 52 may include a metal or plastic frame 56 that retains a plurality of lighting devices 58 such that lighting devices are aligned along an imaginary axis 60. Each of lighting devices 58 may emit a respective conical beam of light 62 centered about an axis of emission 64. Each axis 64 may be parallel to a plane defined by frame 46, parallel to opposing vertical sides 66, 68 of frame 46, and perpendicular to axis 60. Adjacent cones 62 may or may not intersect with each other. Light cones 62 may or may not intersect with, i.e., directly impinge upon, substrate 48.

Respective inner surfaces 70, 72, 74 of vertical sides 66, 68 and top side 76 of frame 46 may be optically reflective such that light emitted from lighting devices 58 is directly or indirectly reflected back onto substrate 48. Further, an inner surface 78 of an opaque substrate 80 that opposes substrate 48 may also be optically reflective for further direct or indirect reflections of light onto substrate 48. Frame 56 of light bar assembly 52 may be formed of aluminum or steel, either of which may be substantially reflective to light for further direct or indirect reflections of light onto substrate 48. Further, frame 56 may be provided with a light-reflective coating, such as white paint. Thus, light bar assembly 52, surfaces 70, 72, 74, 78 and substrate 48 may define therebetween a light chamber 81 in which light may be retained and repeatedly reflected for illumination of substrate 48.

Each lighting device 58 may include a lens, described in more detail hereinbelow, that creates a rectangular beam 62a (FIG. 2a) of light that has a cross section with a length 83 along axis 60 that is very much greater than a width 85 of the cross section of beam 62a in a direction perpendicular to axis 60. Thus, each of the beams of light may have a greater divergence in a direction 60 parallel to substrate 48 than in a direction perpendicular to substrate 48. This arrangement may allow the light to mix evenly and evenly illuminate the desired panel surfaces. The narrow portion of the beam allows the beam to penetrate vertically within light chamber 81 so that there is even illumination from the top to the bottom of the targeted panels. In a particular embodiment, a ratio of length 83 to width 85 is approximately equal to a ratio of a width 87 (FIG. 2) of chamber 81 to a depth 89 of chamber 81. In contrast, round beam lenses may not mix as evenly and may tend to form hot spots of intersecting light beams. Also, round beam lenses may not penetrate as well vertically.

As illustrated in FIG. 3, frame 46 may be provided with a battery compartment 82 in which rechargeable twelve-volt batteries 84 may be stored for powering lighting devices 58. Compartment 82 may be normally covered by a hinged door 86. In one embodiment, batteries 84 may be substantially continuously recharged by a solar panel 88 (FIG. 1) on roof 42. In another embodiment, batteries 84 may be periodically recharged by plugging into a wall receptacle (not shown). In yet another embodiment, no batteries are provided, and lighting devices 58 are directly and continuously plugged into a wall receptacle.

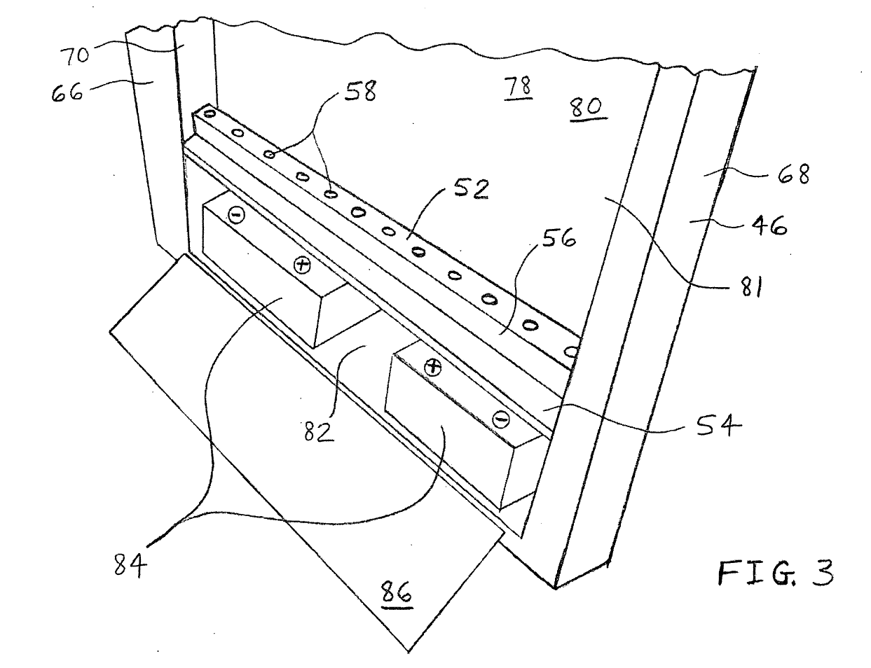

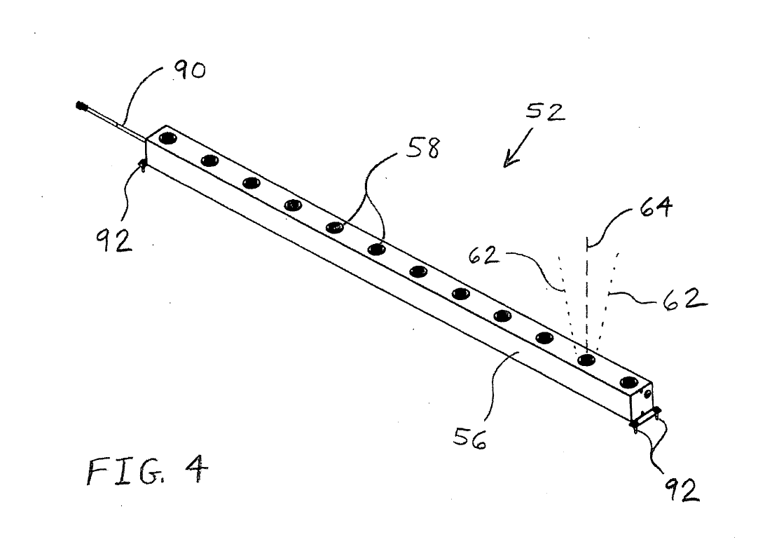

Light bar assembly 52 is illustrated in FIG. 4 as including a power cord 90 for electrically connecting to batteries 84 or a wall socket as described above. Frame 56 may be attached to bottom inner surface 54 of frame 46 via screws 92 or some other type of fastener.

Frame 56 is illustrated in isolation in FIG. 5. Frame 56 includes a plurality of through-holes 94 which are aligned along axis 60. Each of through-holes 94 may receive a respective one of lighting devices 58. Frame 56 may have a front wall 96, top wall 98 and a back wall 100 defining there between a cavity 102 through which lighting devices 58 may be installed into through-holes 94.

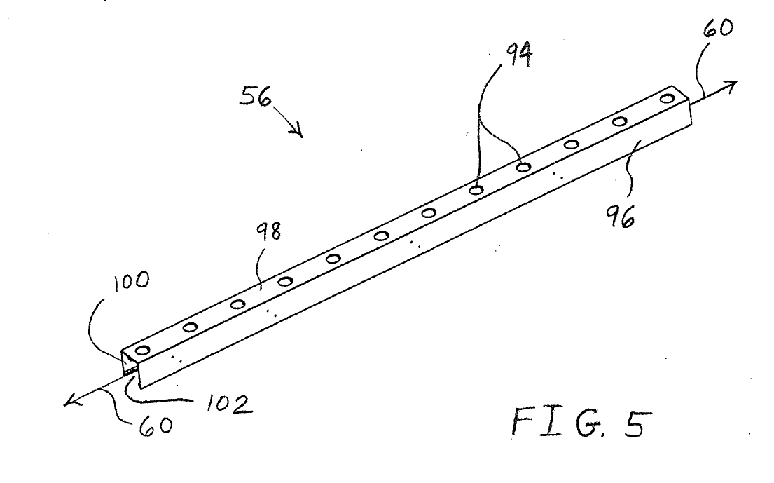

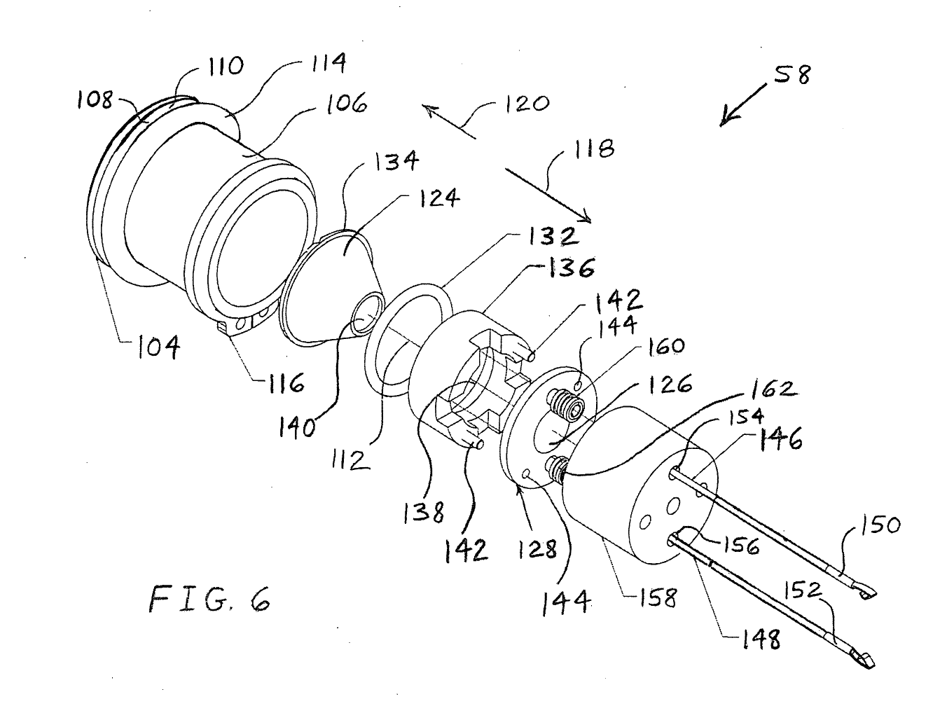

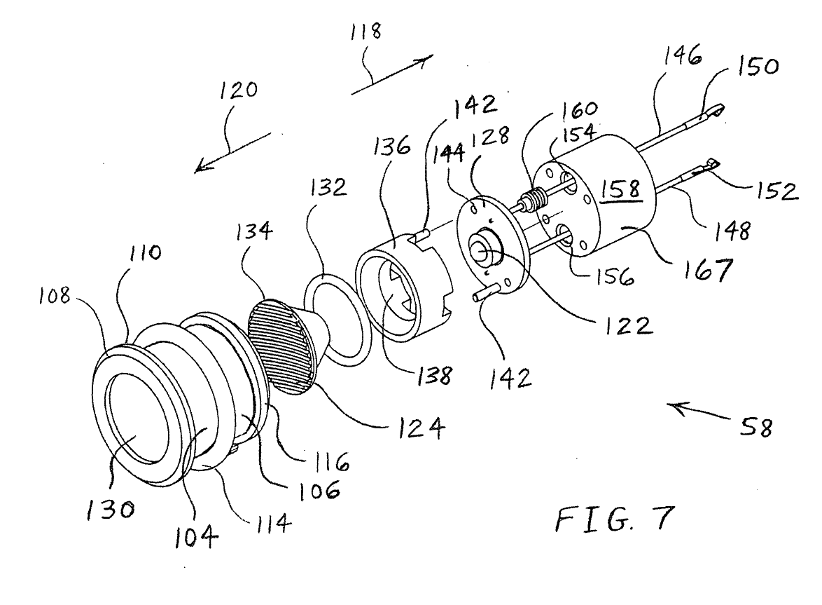

A lighting device 58 is shown in the exploded views of FIGS. 6 and 7. In the illustrated embodiment, lighting device 58 includes a hollow housing 104 having an annular body 106 and an annular flange 108 at one end of body 106. Flange 108 has a radius in a direction perpendicular to an axis 112 of lighting device 58 that is greater than the radius of body 106. Flange 108 has a flat, annular surface 110 that is perpendicular to an axis 112 of lighting device 58 and that faces in an axial direction 114.

A rubber O-ring 114 may be mounted on body 106 such that top wall 98 of frame 58 is clamped between annular surface 110 of flange 108 and O-ring 114. To this end, a retaining ring 116 may be mounted on body 106 such that top wall 98 is clamped between O-ring 114 and retaining ring 116. During assembly, body 106 of housing 104 may be inserted into a through-hole 94 until surface 110 of flange 108 engages top wall 98. Body 106 may be pulled in axial direction 118, and/or flange 108 may be pushed in axial direction 118, while retaining ring 116 is pushed in an opposite direction 120. Retaining ring 116 may be pushed in direction 120 until O-ring 114 is tightly clamped between top wall 98 and retaining ring 116, and top wall 98 is tightly clamped between annular surface 110 and O-ring 114. Retaining ring 116 may then be released to allow it to clamp onto body 106 and thereby hold flange 108 and O-ring 114 in position such that top wall 98 is clamped therebetween. Thus, O-ring 114 may prevent moisture, dust and other elements that enter chamber 81 from reaching the other components of lighting device 58 that are shown in FIGS. 6 and 7. Moreover, the clamping force provided by retaining ring 116 may prevent rotation of lighting device 58 relative to frame 56.

Lighting device 58 may further include a lighting element in the form of a light emitting diode (LED) 122 and a round lens 124 that may be optimized therefor. In one particular embodiment, LED 122 is in the form of a model P4 LED marketed by Seoul Semiconductor, Inc. LED 122 may be received and mounted within a circular opening 126 in a disc-shaped spacer 128. During assembly, lens 124 may be inserted into an opening 130 of housing 104 that is co-planar with flange 108.

A rubber O-ring 132 may engage an annular lip 134 of lens 124 to thereby seal opening 128 such that moisture, dust and other elements that enter chamber 81 are prevented from reaching the other components of lighting device 58 through opening 130. A lens clamp ring 136 may engage O-ring 132 and receive lens 124 in an opening 138 of ring 136 such that LED 122 projects through an opening 140 of lens 124. Lens clamp ring 136 may also maintain LED 122 and lens 124 in a spaced relationship. Lens clamp ring 136 may include dowel pins 142 that may be received in through-holes 144 of spacer 128, as shown in FIG. 6. Alternatively, one or both dowel pins 142 may be provided on spacer 128, and one or more holes may be provided on lens clamp ring 136, as shown in FIG. 7.

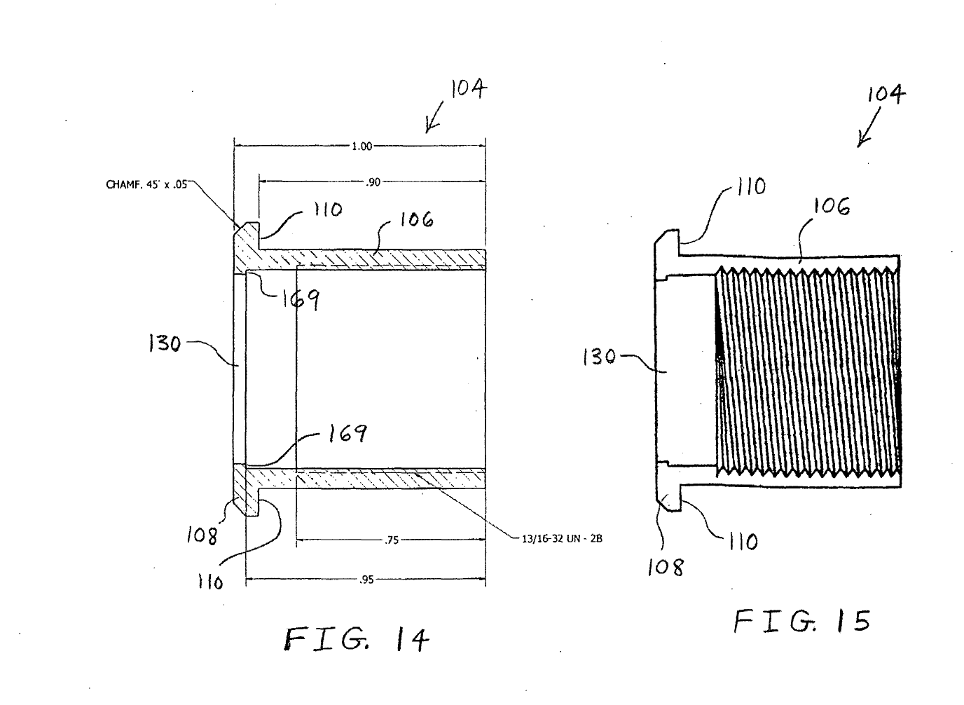

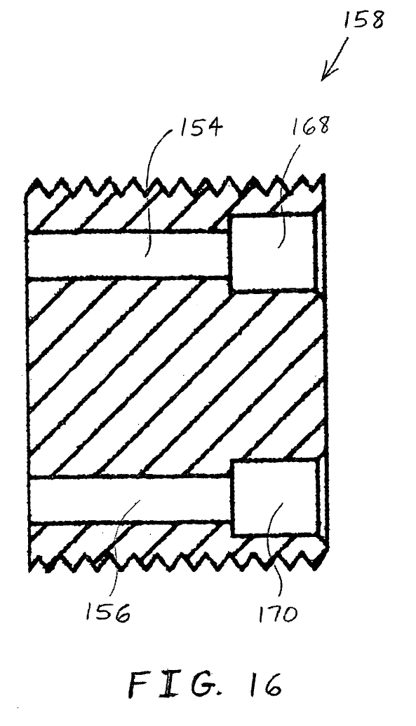

Voltage may be applied to LED 122 via two wires 146, 148 having respective terminals 150, 152. Wires 146, 148 may be routed to LED 122 through spacer 128. Spacer 128 contains the solder pad connections to allow the wires to be electrically connected to the electrical leads of the LED lamp 122. Spacer 128 contains a hole into which is inserted a thermally conductive but electrically insulating disc 129. Thermally conductive paste which is electrically insulating may be applied between LED 122 and disc 129 and/or between disc 129 and plug 158 to increase the thermal conduction from LED 122 to plug 158. Wires 146, 148 may also be routed through respective through-holes 154, 156 in a plug 158. Plug 158 may be inserted into body 106 of housing 104 with an interference fit. Seals 160, 162 may be provided around respective wires 146, 148 for preventing ingress of water, dirt, and other contaminants into housing 104. In one embodiment, plug 158 is externally threaded, as best shown in FIG. 16, and body 106 of housing 104 is internally threaded, as best shown in FIG. 15, such that plug 158 may be screwed into body 106.

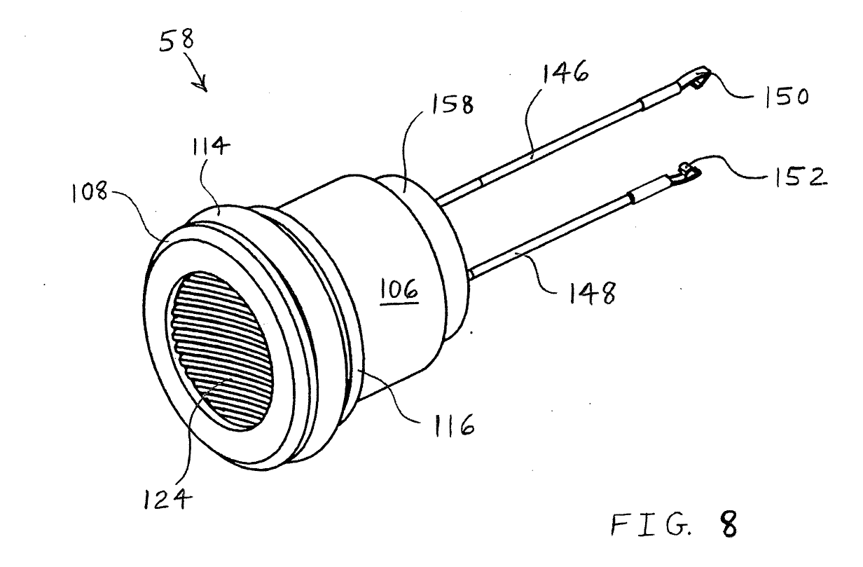

FIG. 8 illustrates lighting device 58 in an assembled state. FIG. 9 is a side view of the assembled lighting device 58 of FIG. 8 with a screw 164 screwed into plug 158 and utilizing an external tooth lock washer 166. Screw 164 and washer 166 do not serve any function in the state illustrated in FIG. 9. However, screw 164 and washer 166 may be used to secure lighting device to some structure, such as a metal plate 165 as illustrated in FIG. 9a.

FIG. 10 is a cross sectional view of the lighting device 58 of FIG. 9 along line A-A. LED 122 may produce a high level of heat that is efficiently carried away from LED 122 to top wall 98 of frame 56. One path along which heat may be carried from LED 122 to top wall 98 is via spacer 128 and body 106, with or without passing through flange 108. Another path is through lens 124 and flange 108. Further, because of the large surface area of plug 158 that is in contact with body 106, a substantial amount of heat may be transferred from LED 122 to top wall 98 through plug 158, and body 106 and also through flange 108 to top wall 98.

In one embodiment, in order to enhance thermal conductivity, housing 104, plug 158 and top wall 98 are formed of a material with a high level of thermal conductivity. For example, housing 104, plug 158 and top wall 98 may each be formed of aluminum, and housing 104 and plug 158 may be provided with a clear anodized finish. In order to further enhance thermal conductivity from plug 158 to body 106, an outer surface 167 (FIG. 7) of plug 158 may be coated with a thermally conductive gel or paste. Thus, LED 122 may be in thermal communication with housing 104.

The gap between wire 146 and the inner wall of through-hole 154, and the gap between wire 148 and the inner wall of through-hole 156, may be filled with a sealant material in order to prevent ingress of moisture, dirt and contaminants into body 106, and to prevent egress of moisture, dirt and contaminants out of body 106. In one embodiment, the sealant may be a silicone-based sealant.

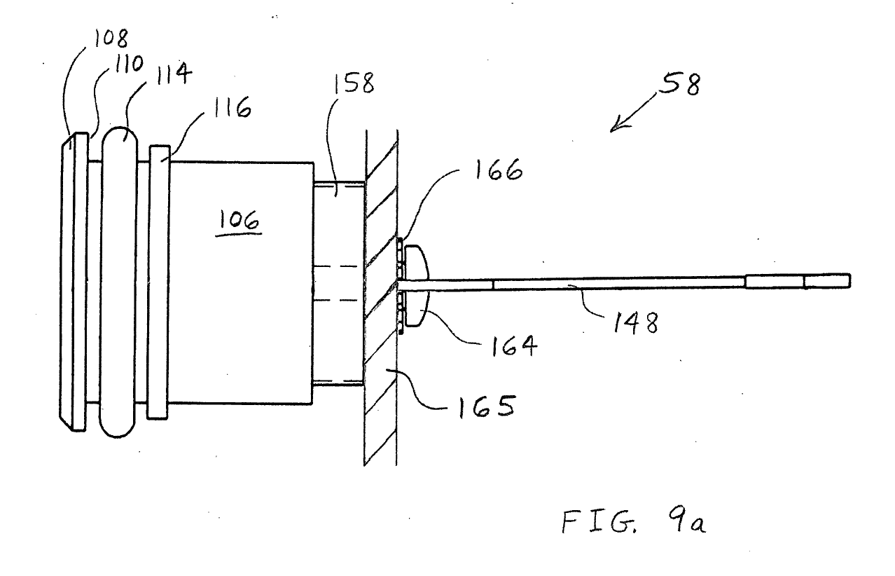

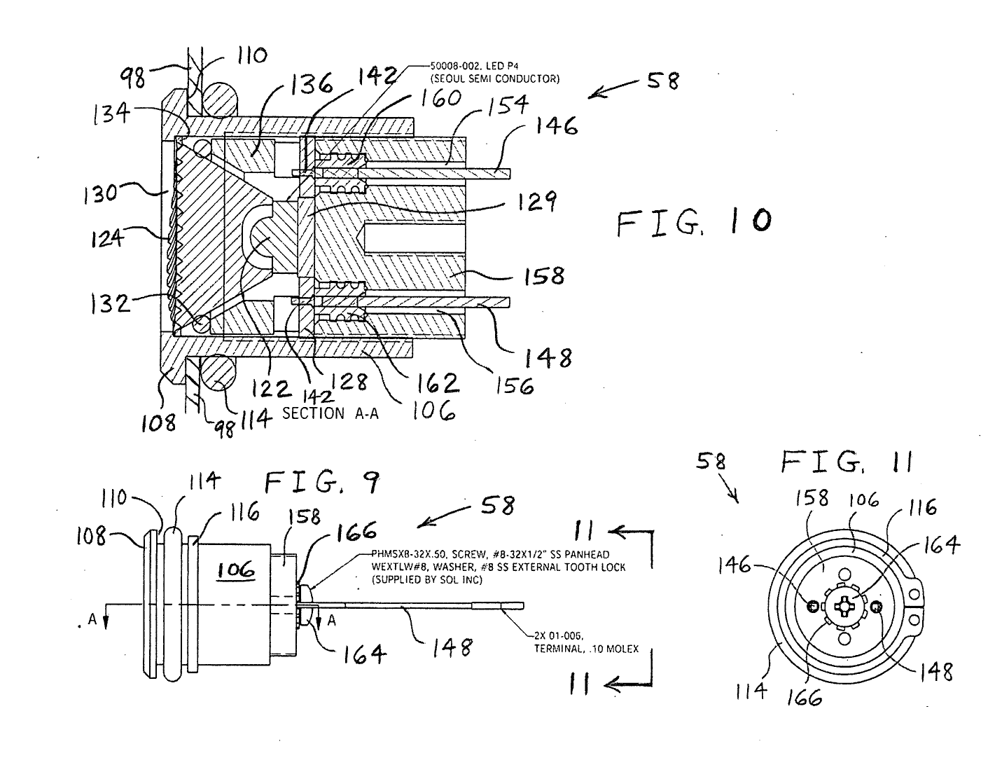

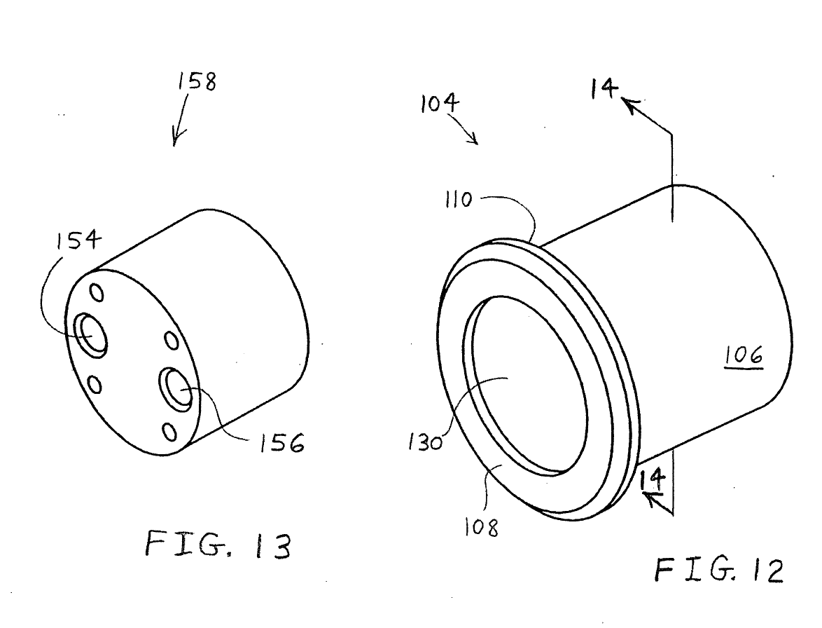

FIG. 11 is a view of lighting device 58 along line 11-11 in FIG. 9. FIG. 12 is a perspective view of housing 104 in isolation, and FIG. 13 is a perspective view of plug 158 in isolation. FIG. 14 is a cross sectional view of housing 104 along line 14-14 in FIG. 12. Housing 104 may include an annular internal shoulder 169 that engages lip 134 as shown in FIG. 10 and thereby prevents lens 124 from protruding through opening 130.

FIG. 15 illustrates one embodiment of housing 104 wherein body 106 is internally threaded for receiving an externally threaded plug 158. One embodiment of such an externally threaded plug 158 is shown in cross-section in FIG. 16. Through-holes 154, 156 include respective enlarged portions 168, 170 of increased radius for receiving seals 160, 162, as best shown in FIG. 10.

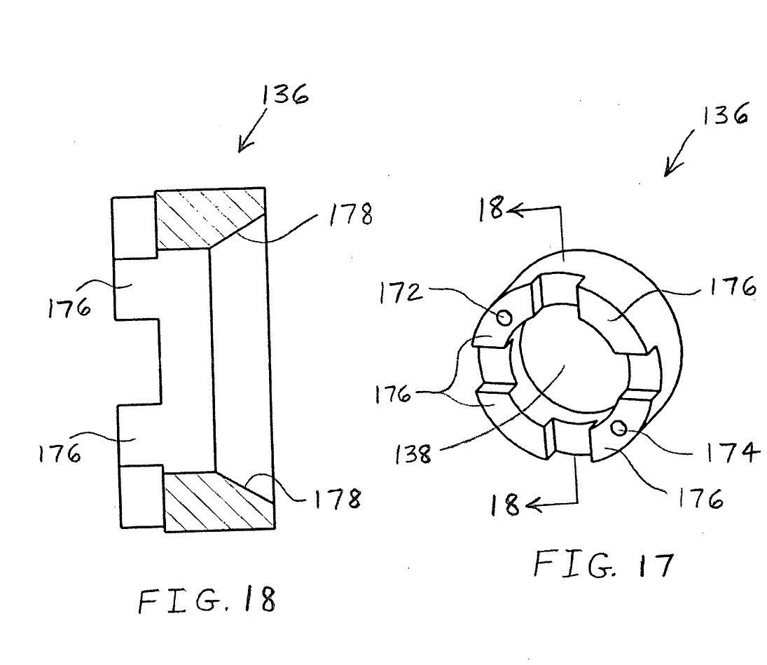

As shown in the embodiment of FIG. 17, lens clamp ring 136 may include recesses 172, 174 for receiving corresponding dowel pins on spacer 128. Lens clamp ring 136 also includes four legs 176 for engaging spacer 128. The dowel pins and legs 176 inhibit rocking of lens clamp ring 136 on spacer 128 and promote stability in the engagement between lens clamp ring 136 and spacer 128. Thus, stability in the orientation of LED 122, and in the direction which the beam of light is emitted therefrom, is also promoted.

As shown in FIG. 18, lens clamp ring 136 may include a frusto-conical tapered wall 178 partially defining opening 138. Wall 178 may accommodate the reception of the frusto-conically-shaped lens 124 within opening 138.

Lens 124 may spread the light in the plane defined by long axis 60 of the light bar and axes of emission 64 while focusing the beam more tightly in the transverse direction. This allows and facilitates an even mixing of the light, providing uniform illumination of the planes 48 and 80 where advertising images are placed for illumination.

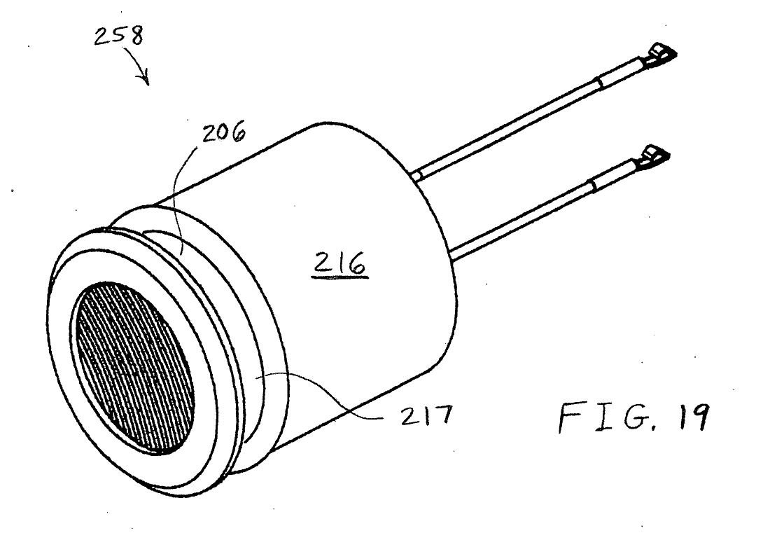

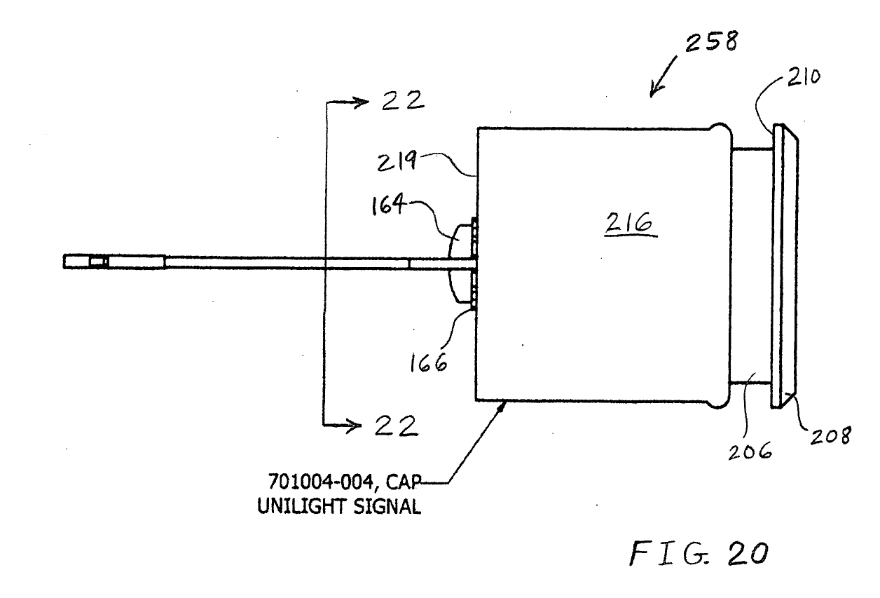

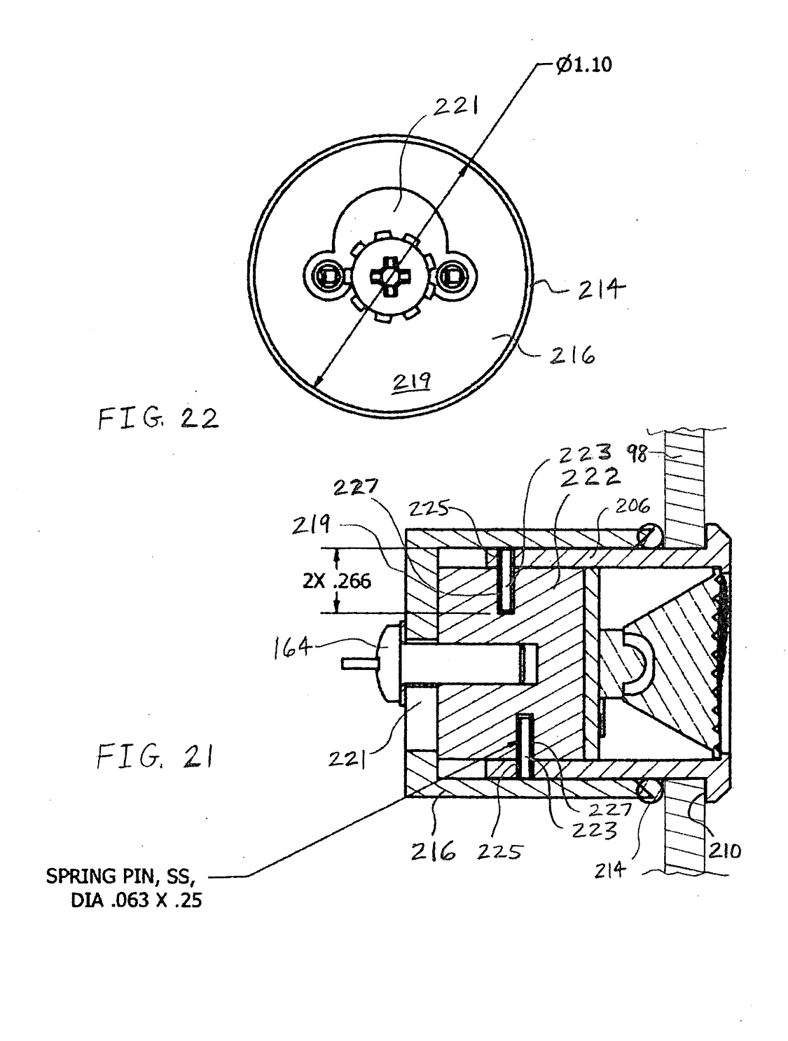

Another embodiment of a lighting device 258 is illustrated in FIG. 19 as including a cap 216 in place of the retaining ring 116 of previous embodiments. Other components of lighting device 258 may be substantially the same as in previous embodiments discussed above. Cap 216 may be cylindrically-shaped with an open end 217 in which body 106 of housing may be partially received. As shown in FIG. 20, cap 216 may fastened to the remainder of lighting device 258 via screw 164. More particularly, as shown in FIG. 21, cap 216 may include a substantially closed end 219 having a through-hole 221 through which screw 164 may be screwed into plug 222 to thereby secure cap 216.

Spring pins 223 may be used to lock plug 222 in position relative to body 206. Body 206 may have through-holes 225 that align with corresponding recesses 227 in plug 222 for receiving spring pins 223. Screw 164 may be tightened to the degree necessary for top wall 98 to be securely clamped between O-ring 214 and surface 210 of flange 208. FIG. 22 is an end view of lighting device 258 along line 22-22 in FIG. 20.

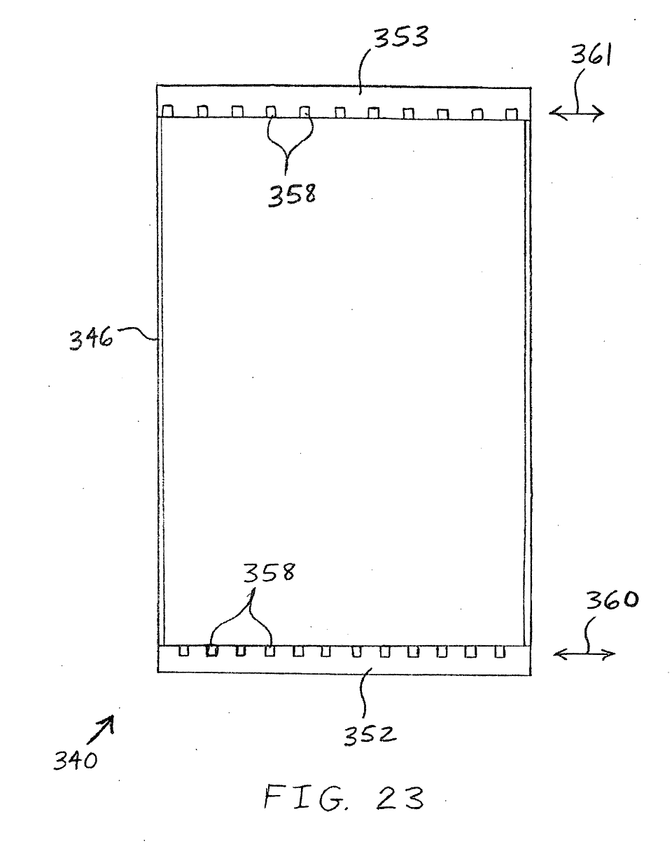

In another embodiment of a signage apparatus 340 illustrated in FIG. 23, light bar assemblies 352, 353 are provided in opposing positions at the bottom and top, respectively, of a rectangular frame 346. Each of light bar assemblies 352, 353 may include a plurality of lighting devices 358 that are aligned in alignment directions 360, 361, respectively.

Each of lighting devices 358 may emit a light beam along a respective axis 364 such that each of axes 364 is parallel to the page of FIG. 23 and parallel to a translucent substrate on which text and/or graphics may be printed. Lighting devices of light bar assembly 352 may be staggered relative to the lighting devices of light bar assembly 353 in alignment directions 360, 361. Thus, axes 364 may be parallel to, and spaced from, each other. In one embodiment, axes 364 are evenly spaced from one another. That is, a distance 363 between adjacent axes 364 may be constant for each pair of adjacent axes 364. Thus, the light provided by lighting devices 358 in light bar assemblies 352, 353 may be evenly dispersed over the translucent, sign-bearing substrate.

The lighting devices have been described herein as being utilized in an internally lighted sign. However, it is to be understood that the lighting devices may be used in other applications, such as for exterior sign lighting, in-vehicle spot lighting, counter lighting, appliance lights and machine lights.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A signage apparatus, comprising:
a translucent substrate having displayed thereon at least one of a textual image and a graphic image, the substrate having a plurality of edges; and
a plurality of lighting devices aligned along one of the edges of the substrate, each of the lighting devices being oriented to emit a respective beam of light in a direction generally parallel to the substrate.

2. The apparatus of claim 1, wherein each of the lighting devices has a respective lens configured to define the respective beam of light, each of the beams of light having a greater divergence in a direction parallel to the substrate than in a direction perpendicular to the substrate.

3. The apparatus of claim 2, wherein each of the beams of light is has a rectangular cross section with two longer sides and two shorter sides, the longer sides being parallel to a direction in which the lighting devices are aligned.

4. The apparatus of claim 2, further comprising a reflective surface disposed along an other edge of the substrate, the reflective surface being oriented substantially perpendicular to the substrate, the reflective surface facing toward the substrate to reflect light from the lighting devices onto the substrate.

5. The apparatus of claim 2, further comprising a reflective surface disposed opposite the translucent substrate and facing the translucent substrate.

6. The apparatus of claim 1, wherein each of the lighting devices is oriented to emit a respective beam of light in a direction generally parallel to and across the substrate.

7. The apparatus of claim 1, wherein the lighting devices comprise first lighting devices and the substrate is rectangular, the apparatus further comprising a plurality of second lighting devices aligned along a second of the edges of the substrate, the second edge being opposite the one edge, the second lighting devices being staggered relative to the first lighting devices in a direction in which the first lighting devices are aligned.

8. A signage apparatus, comprising:
a translucent substrate having displayed thereon at least one of a textual image and a graphic image, the substrate having a plurality of edges;
a plurality of first lighting devices aligned along a first of the edges of the substrate, each of the first lighting devices being oriented to emit a respective beam of light in a first direction generally parallel to the substrate; and
a plurality of second lighting devices aligned along a second of the edges of the substrate, each of the second lighting devices being oriented to emit a respective beam of light in a second direction generally parallel to the substrate.

9. The apparatus of claim 8, wherein each of the first and second lighting devices has a respective lens configured to define the respective beam of light, each of the beams of light having a greater divergence in a direction parallel to the substrate than in a direction perpendicular to the substrate.

10. The apparatus of claim 8, wherein the first direction is substantially opposite to the second direction.

11. The apparatus of claim 8, wherein the first lighting devices are aligned in an alignment direction, and the second lighting devices are aligned in the alignment direction, the first lighting devices being staggered relative to the second lighting devices in the alignment direction.

12. The apparatus of claim 8, further comprising a reflective surface disposed along a third edge of the substrate, the reflective surface being oriented substantially perpendicular to the substrate, the reflective surface facing an area of space disposed between the first lighting devices and the second lighting devices such that the reflective surface reflects light from the lighting devices onto the substrate.

13. The apparatus of claim 8, further comprising a reflective surface disposed opposite the translucent substrate and facing the translucent substrate.

14. A lighting arrangement, comprising:
a thermally conductive plate having a through-hole; and
a lighting device including:
an integral, thermally conductive housing having a body snugly received in the through-hole, the housing also having a flange disposed around an open end of the body, the flange having a width greater than a width of the through-hole, a substantially flat surface of the flange engaging the plate; and
a lighting element disposed within the body and in thermal communication with the housing, the light element being oriented to emit light directly through the open end of the body.

15. The arrangement of claim 14, wherein the lighting device has a lens that emits the light in a rectangular beam, the beam having a cross section with a length that is greater than a width of the cross section.

16. The arrangement of claim 14, wherein the body has a second open end, the lighting device further including a thermally conductive plug received in the second open end, the plug being in thermal communication with each of the lighting element and the housing.

17. The arrangement of claim 14, wherein the flat surface of the flange engages a first side of the plate, the arrangement further comprising:
an O-ring disposed around the body and engaging a second side of the plate opposite the first side; and
a retaining ring disposed around the body and biasing the O-ring against the second side of the plate.

18. The arrangement of claim 14, wherein the body includes a shoulder at the open end, the lighting device including a lens disposed between the lighting element and the open end, the lens engaging the shoulder.

19. The arrangement of claim 14, wherein the plate include a plurality of aligned through-holes, the arrangement further comprising a plurality of other lighting devices, each of the lighting devices being received in a respective one of the through-holes.

20. The arrangement of claim 19, wherein the lighting devices are oriented such that the lighting devices emit substantially parallel light beams.
